(19) United States
(12) Patent Application Publication
(10) Pub. No.: US 2005/0083350 A1
(43) Pub. Date: Apr. 21, 2005

(54) Digital camera image editor

(76) Inventor: Amy E. Battles, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/688,513

(22) Filed: Oct. 17, 2003

(51) Int. Cl. G09G 5/00

(52) U.S. Cl. 345/660

(57) ABSTRACT

An embodiment of a method for editing image information with a digital camera comprises identifying image information, generating a representation of the image information, magnifying the representation using a discrete magnification step proximal to a midpoint of the digital camera's range for digitally magnifying the image information to produce a modified representation of the image information, presenting the modified representation of the image information, controllably magnifying the modified representation responsive to a magnification control associated with the digital camera, and controllably panning across the modified representation such that preferred subject matter is observable in a desired representation.

### BACKGROUND

Digital cameras are gaining in popularity and becoming more and more widely available to a larger number of consumers. One of the advantages that a digital camera enjoys over a conventional film camera is that when a digital camera acquires an image, image information is stored electronically in a memory element associated with the camera. The image information can then be used to generate a representation of the acquired image that is available for immediate viewing. For example, it is common for digital cameras to acquire an image and then immediately present a representation of the acquired image to the user on a display associated with the camera. The ability to view a representation of the acquired image is commonly referred to as “instant review.” The ability to review the acquired image allows the user to decide if the acquired image is satisfactory. Acquired images deemed unsatisfactory, for any of a number of reasons, by an operator of the digital camera, can be deleted by removing an index to the portion of memory used to store the image information.

Many digital cameras provide users with multiple operating modes. Digital camera users select a desired mode from one of the multiple operating modes. Generally, digital cameras include “setup,” “acquire,” and “playback” modes.

The setup mode often presents a menu-driven graphical-user interface on a display associated with the digital camera. Menu options are selected via one or more input mechanisms associated with the camera. The menu options enable a user of the digital camera to configure any of a number of parameters, including but not limited to, optical settings and acquired image quality. The acquire mode energizes an image sensor, configures the digital camera's operational parameters in accordance with information entered or confirmed while in setup mode, and enables a shutter pushbutton to controllably transfer image information from the image sensor to a memory device associated with the camera. Many digital cameras provide a near real-time representation of the image information on a display when the camera is in the acquire mode. The playback mode enables a user to selectively view one or more representations of previously acquired images stored within the memory associated with the digital camera. A user of the camera can controllably view each representation in the order the image information was stored.

Generally, the setup, acquire, and playback modes are exclusive of one another. That is, available features and operable controls associated with the setup mode are not made available or operable when a user configures the digital camera to either of the acquire and playback modes. Similarly, features and controls associated with the acquire mode are not available and operable when the camera is in setup or playback modes. Features and controls associated with the playback mode are not available and operable when the camera is in either the acquire mode or the setup mode. Thus, a user reviewing previously acquired images is prevented from simultaneously aiming the digital camera and acquiring a new image.

One design consideration that has led to the above-mentioned multiple mode interface is the desire to share limited memory and display resources. For example, a display associated with the camera presents a graphical-user interface when the camera is in the setup mode. The same display is often used to present a representation of each acquired image when the camera is in playback mode. This same display can also be used to present a real-time representation of the image information being collected by the image sensor when the camera is in acquire mode.

Typically, the entire range of image information is used to generate image representations on the associated display. Some digital cameras include a feature that enables a user to view a manipulated version of the image information that simulates a magnified view of a select image. These implementations provide a limited number of discrete magnification levels that are responsive to one or more control inputs when the digital camera is in the playback mode. The arrangement and nature of subject matter acquired in the image information, however, often renders the use of discrete magnification steps inadequate to provide a user with a desired magnification control as image information is often over or under cropped. An image is over cropped when some portion of the desired subject is not presented in the image. An image is under cropped when undesired image information remains in the image.

Many digital cameras also offer the option of directing the transfer of image information from the camera to a suitably configured printing device coupled to the digital camera. After controllably deleting the image information associated with undesired images, the user selects a “transfer pictures” option from a menu driven interface that can be accessed in the setup mode. Once enabled, the transfer pictures option forwards the image information to the printing device. In some implementations, the image information is forwarded to a computer via an intermediate docking station for storing, editing, and communicating acquired images. The computer can later be used to direct a printer to generate prints of the images. Not all potential users of digital cameras have access to a computer that has suitably configured software tools to edit received image information.

Accordingly, improved ways are needed to initiate, control, or otherwise provide desired image information to a printing device coupled to a digital camera.

### SUMMARY

One embodiment teaches a digital camera comprising an image playback system that presents a representation of an image, a magnification control including a zoom in switch and a zoom out switch to effect respective zoom in and zoom out operations on the representation, and a position control including an up switch, a down switch, a left switch, and a right switch to effect respective up, down, left, and right pan operations on the representation.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an embodiment of a digital camera.

FIG. 2 is a schematic diagram illustrating logic stored within the internal memory of the digital camera of FIG. 1.

FIG. 3 is a flow chart illustrating an embodiment of a method for providing image information that can be implemented by the digital camera of FIG. 1.

FIG. 4 is a flow chart illustrating operation of the image magnifying, panning, and transfer functions of the digital camera of FIG. 1.

FIG. 5A is a schematic illustrating an example of a menu driven graphical user interface presented on the display of the camera of FIG. 1.

FIG. 5B is a schematic illustrating an example of the image of FIG. 5A magnified in an initial magnification step.

FIG. 6 is a schematic illustrating an embodiment of the magnification range of the digital camera of FIG. 1.

FIGS. 7A through 7F are graphical illustrations showing an example of the operation of an embodiment of the magnification logic of FIG. 2.

FIGS. 8A and 8B are graphical illustrations showing an example of the operation of an embodiment of the transfer logic of FIG. 2.

FIG. 9 is a flow diagram illustrating an embodiment of a method for editing image information.

FIG. 10 is a flow diagram illustrating an alternative embodiment of a method for editing image information.

### DETAILED DESCRIPTION

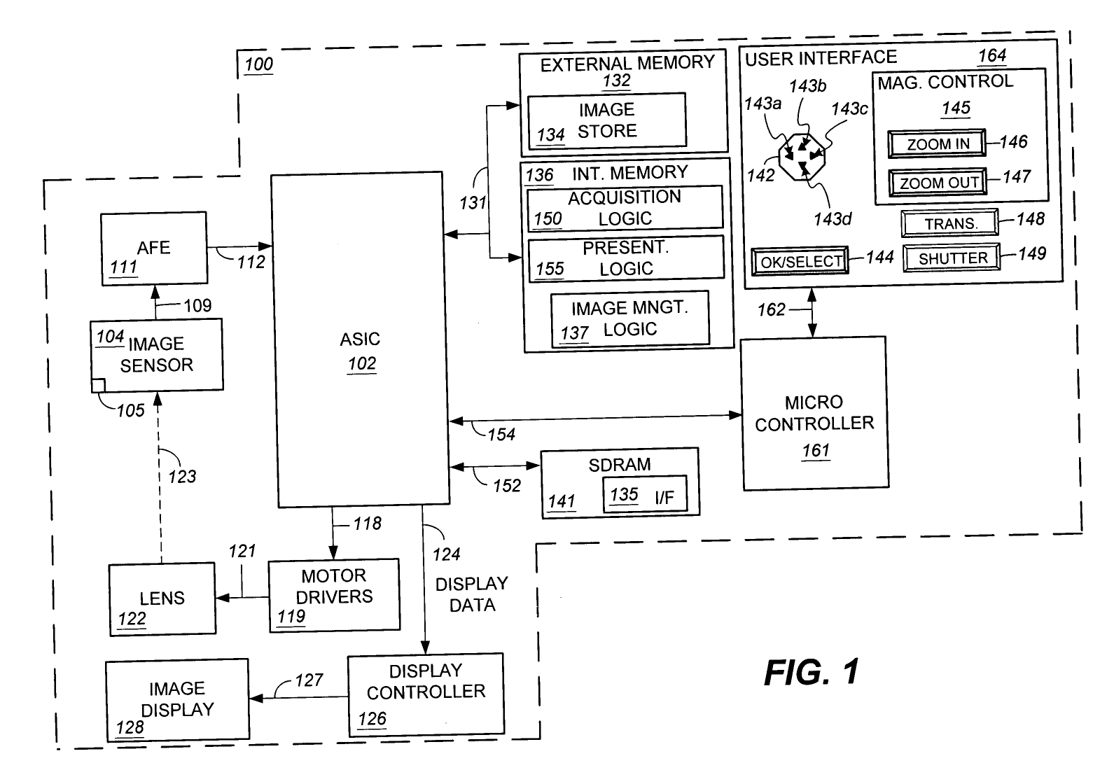

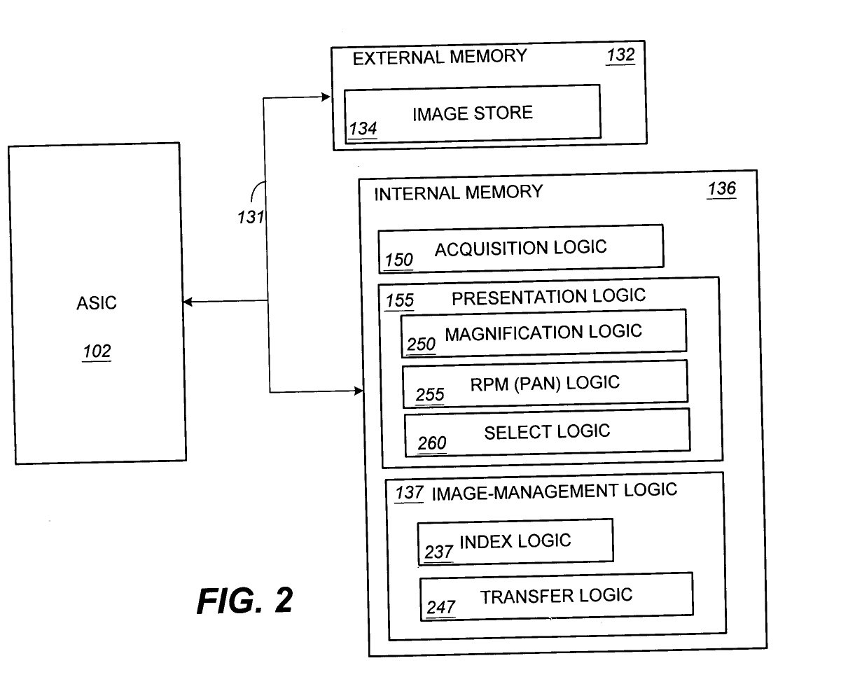

FIGS. 1 and 2 present embodiments of a digital camera. The digital camera includes a user interface that includes a magnification control, a position control, and an image transfer control. The magnification, position, and image transfer controls are co-operable with the digital camera's image acquisition system. The user interface, when coupled with a display device, enables an operator of the camera to controllably magnify a previously acquired imaged to a desired magnification level and positionally adjust (i.e., pan across) the magnified image until a desired subject matter is preferably positioned in a representation of the image. A user of the digital camera can magnify, positionally adjust, and controllably crop captured images. An image box provides graphical feedback via the display device. Modified images can be viewed, marked, and stored on the digital camera.

The digital camera can be coupled directly to suitably configured printers and computers. Image transfer operations forward modified image representations to the coupled devices. When, the image transfer control is enabled, the digital camera responds by transferring image information associated with the representation on the display device or alternatively transfers select modified images from the digital camera.

Embodiments of the digital camera and methods for editing image information described herein can be implemented in hardware, software, firmware, or a combination thereof. The embodiments may be implemented using a combination of hardware and software or firmware that is stored in a memory and that is executed by a suitable instruction execution system associated with a digital camera. The hardware portion can be implemented, by way of example and not limitation, with any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc. The software portion can, for example, be stored in one or more memory elements and executed by a suitable general purpose or application specific processor.

Software for magnifying an acquired image, which may comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the illustrated embodiments, an ASIC processes executable instructions stored in an internal memory within the digital camera. In the context of this document, a “computer-readable medium” can be any means that can contain, store, communicate, propagate, or transport the program for use by or in connection with the instruction execution system, apparatus, or device.

FIG. 1 is a block diagram illustrating a digital camera 100. In the implementation described below, the digital camera 100 includes an application specific integrated circuit (ASIC) 102 that controls the function of various aspects of the digital camera 100. ASIC 102 executes acquisition logic 150, presentation logic 155, and image-management logic 137, among others. Acquisition logic 150 directs motor drivers 119, lens 122, and image sensor 104 to collect and convert incident light responsive to subject matter. Presentation logic 155 converts a digital representation of acquired image information for rendering via display controller 126 and image display 128. Image-management logic 137 maintains an image index for acquired and internally stored images and includes image-transfer logic for controllably communicating image information. The acquisition logic 150, presentation logic 155, and image-management logic 137 can be software that is stored in memory and executed by the ASIC 102. In an alternative embodiment, the acquisition logic 150, presentation logic 155, and image-management logic 137 may be implemented in firmware, which can be integrated in ASIC 102. While illustrated as using a single ASIC 102, the digital camera 100 may include additional processors, digital-signal processors (DSPs), and ASICs to enable various functions and operations.

Digital camera 100 includes an image sensor 104. The image sensor 104 may comprise a charge-coupled device (CCD) array or an array of complementary metal-oxide semiconductor (CMOS) sensors. Regardless of whether the image sensor 104 comprises an array of individual CCD elements or CMOS sensors, each of the elements in the array comprises a pixel (picture element) of the image sensor 104. An exemplary image element, or pixel, is indicated using reference numeral 105. The pixels in the image sensor 104 are typically arranged in a two-dimensional array. For example, an image array may comprise 2272 pixels in length and 1712 pixels in height.

The image sensor 104 produces analog image data representative of a subject by converting light incident on the image sensor 104 into an analog signal. The analog signal is forwarded via connection 109 to an analog front-end (AFE) processor 111. The analog front-end processor 111 typically includes an analog-to-digital converter for converting the analog signal received from the image sensor 104 into a digital signal and provides this digital signal as image data via connection 112 to the ASIC 102 for image processing.

ASIC 102 is coupled via connection 118 to one or more motor drivers 119. The motor drivers 119 control the operation of various parameters of the lens 122 via connection 121. For example, lens controls, such as optical zoom, focus, aperture, and shutter operations are controlled by ASIC 102 via the motor drivers 119. Connection 123 between the lens 122 and the image sensor 104 is shown as a dotted line to illustrate the operation of the lens 122 focusing on a subject and communicating imaging light to the image sensor 104, which converts the optical image provided thereon by the lens 122 into an electrical signal.

The ASIC 102 also sends display data via connection 124 to a display controller 126. The display controller may be, for example, a national television system committee (NTSC)/phase-alternate line (PAL) encoder, although, depending on the application, other standards for presenting display data may be used. The display controller 126 converts the display data from the ASIC 102 into a signal that can be forwarded via connection 127 to image display 128. The image display 128, which can be, for example, a liquid-crystal display (LCD) or other display, visually presents a display image produced from image data to the user of a digital camera 100. Depending on the configuration of the digital camera 100, the display image shown to a user on the display 128 may be shown before the image is acquired and processed in what is referred to as a “live view” mode, or after the image is acquired and processed, in what is referred to as “playback” mode. The “playback” mode is used to display an acquired image after the image is acquired.

“Image acquisition” refers to the act of designating a scene that is currently being imaged on the image sensor 104 as an image that is to be stored, at least temporarily, as data in some portion of the digital camera's memory. Such an image, or its representative image information, is referred to as an “acquired image.” An acquired image in a digital camera is roughly analogous to an image that is fixed by a film camera by exposing a portion of light-sensitive film. Image acquisition is usually initiated by pushing a button, such as shutter 149, on the digital camera 100.

Image display 128 is also used to display various user interface information and operational menus. As will be described below, representations of previously acquired images can be controllably viewed on the image display 128 during playback mode. A user of the digital camera 100 can enter playback mode via any number of alternative actions that can be programmed in one or more of the memory devices associated with the digital camera 100. For example, the digital camera 100 can be configured with a mode selector (not shown) that applies suitable user inputs via enabled input devices (i.e., controls, switches, pushbuttons, etc.) to direct operation of the digital camera 100.

When an operator directs the digital camera 100 to enter playback mode, a menu option is displayed on a portion of image display 128 that enables appropriate user inputs to controllably identify any portion of the image, including the entire image information if desired, to be transferred to a device coupled to the digital camera 100. A portion of the acquired image information is identified by controllably magnifying a representation of the acquired image and panning across the representation until the representation on the image display 128 is acceptable to the operator of the digital camera. The operator then selects an appropriate control input to initiate an image transfer to the device. Thereafter, the digital camera 100 provides visual feedback to the operator by displaying the acquired image with some indicia of that portion of the acquired image information forwarded to the coupled device.

The ASIC 102 couples to a microcontroller 161 via connection 154. The microcontroller 161 can be a specific or a general-purpose microprocessor that controls the various operating aspects and parameters of the digital camera 100. For example, the microcontroller 161 is coupled to a user interface 164 via connection 162. The user interface 164 may include, for example but not limited to, a position control 142, an “OK/select” button 144, a magnification control 145, a transfer control 148, and shutter 149. The user interface 164 may further include one or more additional buttons or mechanisms (not shown), including a pointing device, and other buttons or switches that allow the user of the digital camera 100 to input commands and control features of the digital camera 100. The pointing device and other buttons or switches can provide user inputs to one or more operational menus on the digital camera 100.

The ASIC 102 also couples to one or more different memory elements. It should be noted that while specific types of memory are denoted below, the digital camera 100 may employ various other types of memory not specifically described herein. For example, the various memory elements may comprise volatile, and/or non-volatile memory, such as, for example but not limited to, random-access memory (RAM), read-only memory (ROM), and flash memory. Furthermore, the memory elements may be either internal to the digital camera 100 or may be removable memory media, and may also comprise memory distributed over various elements within the digital camera 100.

In the embodiment shown in FIG. 1, the ASIC 102 couples to synchronous-dynamic random-access memory (SDRAM) 141 via connection 152. The SDRAM 141 houses the various software and firmware elements and components (not shown) that allow the digital camera 100 to perform its various functions. SDRAM 141 also provides temporary storage for image file 135. When the image acquisition, presentation, and management functions are implemented in software, the software code (i.e., the acquisition logic 150, the presentation logic 155, and image-management logic 137) is typically stored in the internal memory 136, a flash memory, and transferred to the SDRAM 141 to enable the efficient execution of the software in the ASIC 102.

The ASIC 102 also couples via connection 131 to an external memory 132, which can also be flash memory. External memory 132 provides image storage for acquired images via image store 134. Similarly, internal memory 136 may provide image storage (not shown) for acquired images.

FIG. 2 is a schematic diagram further illustrating logic stored within the internal memory 136 of the digital camera 100. As illustrated in FIG. 2, internal memory 136 includes acquisition logic 150, presentation logic 155, and image management logic 137. As described above, acquisition logic 150 includes executable statements configured to direct the motor drivers 119, lens 122, and image sensor 104 to acquire an analog representation of light incident upon the various elements 105 comprising image sensor 104.

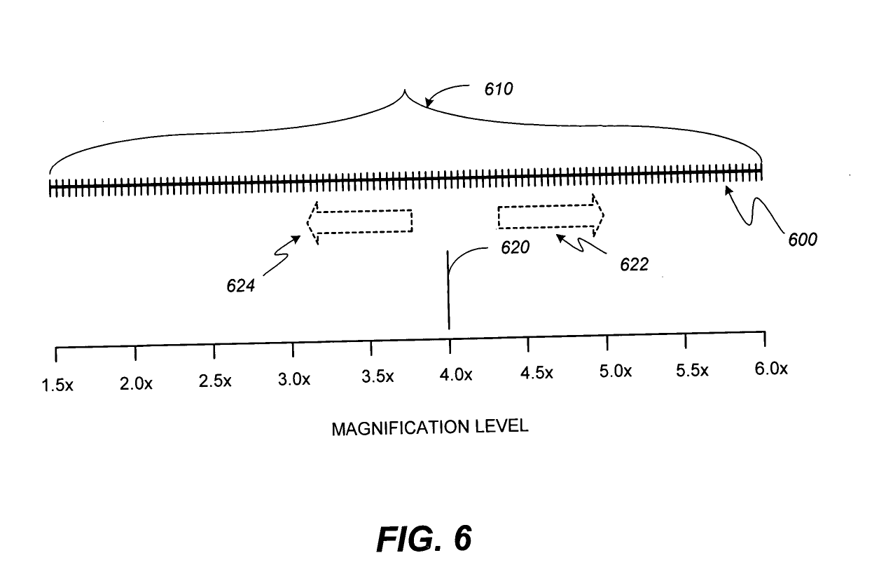

Presentation logic 155 includes magnification logic 250, relative position movement (RPM) hereafter described as pan logic 255, and select logic 260. Magnification logic 250 includes executable statements for manipulating image information through a number of magnification levels ranging from a minimum magnification level to a maximum magnification level. One embodiment implements a magnification range from a 1.5× magnification to 6.0× magnification. Magnification logic 250 can be enabled in response to one or more user selectable inputs. These inputs can include a menu selection, a magnification entry mode pushbutton, or other controls associated with digital camera 100. Once enabled, the magnification logic 250 can be configured to provide an initial magnified representation of image information associated with an acquired image of interest. The initial magnified image will be described in further detail below in association with the schematic diagram illustrated in FIG. 6.

Once enabled, magnification logic adjusts the image information in response to user operation of the zoom in control 146 and the zoom out control 147. Selection of the zoom in control results in a corresponding increase of the magnification level used to produce the magnified representation on image display 128. Selection of the zoom out control 147 results in a corresponding decrease of the magnification level used to produce the magnified representation on image display 128. Note that an operator of the digital camera 100 can choose not to further magnify the image representation on display 128 beyond the initial magnification. In an alternative embodiment, magnification logic 250 is responsive to one or more optical zoom controls (not illustrated) in FIG. 1

Pan logic 255 executes pan operations in response to user inputs applied to position control 142. Selection of the up switch 143b (FIG. 1) directs the digital camera 100 to scroll across the magnified image representation such that the image moves closer to the upper limit of the acquired image information associated with the representation on the display 128. Selection of the down switch 143d directs the digital camera 100 to scroll across the magnified image representation such that the image moves closer to the lower limit of the acquired image information. Selection of the left switch 143a directs the digital camera 100 to scroll across the magnified image representation such that the image moves closer to the left limit of the acquired image information. Selection of the right switch 143c directs the digital camera 100 to scroll across the image such that the image moves closer to the right limit of the image information. Note than an operator of the digital camera 100 can choose not to modify the magnified image via position control 142, thus, using only the initial magnification level to modify the representation of the acquired image. Alternatively, an operator of the digital camera 100 can controllably manipulate the magnified representation via zoom in 146, zoom out 147, and position control inputs in any desired order.

Select logic 260 executes image information operations in response to a user input applied via transfer control 148. Selection of the transfer control 148 directs the digital camera 100 to identify the image information that corresponds to the modified image presentation observable on image display 128. Once that portion of the acquired image information is identified, the select logic 260 forwards the portion of the acquired image information to a communicatively coupled device. In addition, select logic 260 provides the image display 128 with the acquired image information and generates a mark or marks that are overlaid or otherwise inserted into the image information to demark that portion of the originally acquired image that was selected for transfer to the coupled device. In one embodiment, the select logic 260 uses a bounding box to identify the transferred image information. In alternative embodiments, dashed lines, corner marks, etc. serve as indicia of the transferred image information.

As further illustrated in FIG. 2, image-management logic 137 includes index logic 237 and transfer logic 247. Index logic 237 logs and tracks memory locations for each image acquired and stored by the digital camera 100. Index logic 237 interfaces with the various operational menus accessible in the playback mode to review and controllably manipulate each previously acquired image as desired. Transfer logic 247 controls, manages, and verifies the successful transfer of image information to one or more devices coupled to digital camera 100. Transfer logic 247 is enabled in response to a user directed input via transfer control 148.

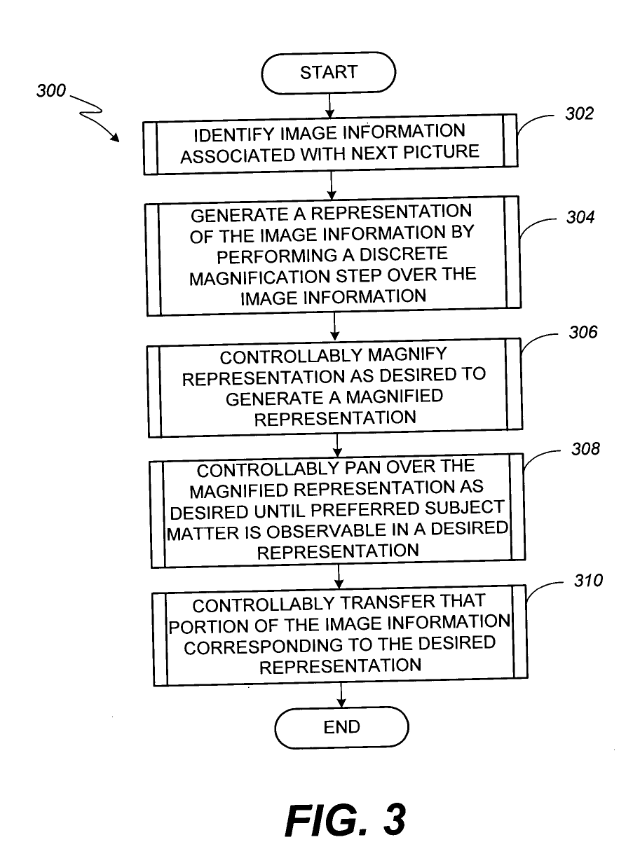

Any process descriptions or blocks in the flow charts illustrated in FIGS. 3, 4, 9, and 10 should be understood as representing modules, segments, or portions of code which include one or more executable instructions for implementing specific logical functions or steps in the associated process. Alternative implementations are intended to be included within the scope of the invention as set forth in the appended claims. For example, functions may be executed out of order from that shown or discussed, including substantially concurrently or in reverse order, depending on the functionality involved, as would be understood by those reasonably skilled in the art.

FIG. 3 is a flow chart illustrating an embodiment of a method 300 for providing image information that can be implemented by the digital camera of FIG. 1. As illustrated in FIG. 3, method 300 begins with block 302 where the digital camera 100 identifies image information associated with an acquired image or picture. Next, as shown in block 304, the digital camera 100 generates a representation of the image information identified in block 302. The representation is responsive to a discrete magnification step applied over the image information. Thereafter, in accordance with input from one or more controls associated with the digital camera 100, the representation is controllably magnified to generate a magnified representation as indicated in block 306. Thereafter, as indicated in block 308, inputs from one or more controls associated with digital camera 100 are used to controllably pan across the magnified representation to arrange subject matter such that is observable in a preferred position in the modified representation. As indicated in block 310, after an operator of the digital camera 100 is satisfied with the magnification and position of subject matter in the representation, and in accordance with an input associated with the digital camera 100, that portion of the image information associated with the displayed representation is transferred.

An operator of the digital camera 100 can configure the magnification logic to apply an initial magnification level before presenting an image representation on display device 128 and enabling the magnification control 145. The initial magnification level can be user adjusted to fall anywhere within the digital camera's magnification range.

Note that an operator of the digital camera 100 does not necessarily have to adjust the acquired image representation before initiating an image transfer to a coupled device. Moreover, the operator has the option to controllably pan and controllably magnify the image representation in any order and any number of times to produce the desired image representation before selecting transfer control 148.

As described above, when desired, the image transfer can occur between digital camera 100 and a printer communicatively coupled to the digital camera 100, configured to receive the image information, and generate one or more prints corresponding to the image information. Alternatively, the image information can be transferred to a computer or other devices coupled to the digital camera 100. The computer can provide long term digital image storage. When the computer is provided with suitably configured software, the computer and software provide an image editing platform with further image-editing capabilities.

In alternative embodiments, an operator of the digital camera 100 reviews and edits previously acquired and stored digital images absent an immediate intention to transfer the modified image information. The operator uses the above-described discrete magnification step, the fine magnification control, and the position controls to position a crop box or other indicators over the modified representation. Image information bounded by the crop box or otherwise marked by the indicators will be forwarded when an operator of the digital camera 100 elects to transfer the modified and stored image representations.

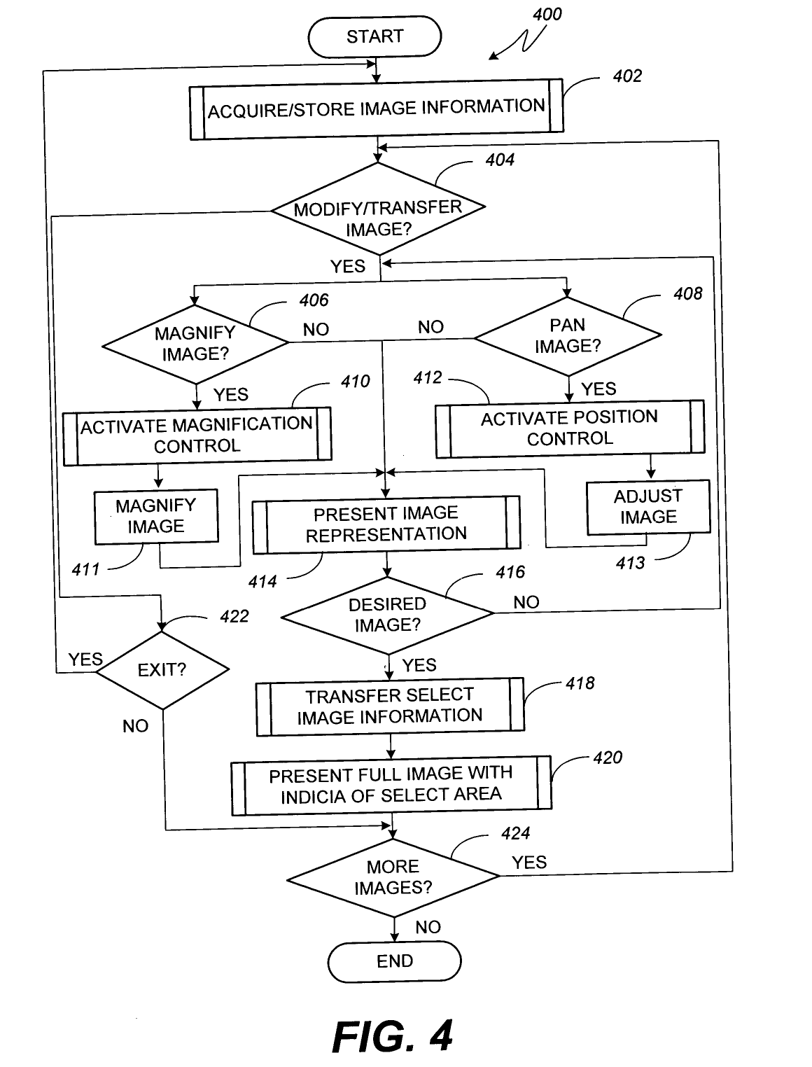

FIG. 4 is a flow chart 400 describing operation of an embodiment of the digital camera 100 of FIG. 1. In block 402 the image sensor 104 of FIG. 1 acquires an image. The image can be stored in the internal memory 136 or in the external memory 132 and is also represented as image file 135 in the SDRAM 141 of FIG. 1.

In decision block 404, after the digital camera 100 has been directed to operate in a playback mode, an acquired image is displayed to the user of the digital camera 100 via the image display 128 (FIG. 1) and the operator is queried whether it is desired to modify and/or transfer the acquired image. The playback mode affords the user the opportunity to review the acquired image before performing subsequent processing tasks, such as magnifying, panning, and transferring associated image information from the digital camera 100.

As indicated in the flowchart 400, when the operator desires to modify and/or transfer the acquired image, as indicated by the flow control arrows labeled “YES” exiting decision block 404, the operator is presented with parallel capabilities to magnify and/or pan the image representation. Otherwise, processing continues with decision block 422 where a determination is made whether to exit playback mode. When it is determined to remain in playback mode, as indicated by the flow control arrow labeled “YES” exiting decision block 422 processing continues by returning the digital camera to an acquisition mode as indicated in step 402. In one embodiment, digital camera 100 is fully operational when an operator is reviewing and controllably modifying image representations using visual feedback via the image display 128. That is, the image acquisition system of the digital camera is energized and capable of acquiring new images by pointing the lens 122 at a new subject of interest and entering a shutter input via shutter 149.

As shown by the flow control arrow labeled “YES” exiting decision block 406, when the operator desires a magnified version of the displayed representation, the digital camera 100 enables magnification logic and the associated magnification control 145 as further shown in block 410. Thereafter, the digital camera 100 magnifies the image representation in accordance with inputs from the zoom in control 146 and zoom out control 147 as indicated in block 411. As also shown by the flow control arrow labeled “YES” exiting parallel decision block 408, when the operator desires a different relative position of the subject matter of the displayed representation, the digital camera 100 enables pan logic 255 and the associated position control 142 as further shown in block 412. Thereafter, the digital camera 100 positionally adjusts the image in accordance with inputs from position control 142 as indicated in block 413. Otherwise, when an operator of the digital camera 100 does not desire to magnify the image representation, the digital camera 100 presents the image representation as indicated in block 414. Similarly, when an operator of the digital camera 100 does not desire to positionally modify or pan the image, the digital camera 100 presents the image representation as indicated in block 414.

Next, as indicated by decision block 416, the operator determines if the present image representation reflects a desired image. When the image is not modified in a manner resulting in a desired image, as indicated by the flow control arrow labeled “NO” exiting block 416, processing continues over blocks 406 through 416 until a desired image is achieved. Otherwise, when a desired image is obtained, the digital camera 100 responds to a user input entered via the transfer control 148 by transferring the select image information as indicated in block 418. Thereafter, as illustrated in block 420, the digital camera 100 provides visual feedback to the operator by presenting a representation that includes the acquired image as well as indicia denoting the select image information transferred in block 418.

When processing under the playback mode is further desired, as indicated by the flow control arrow labeled “NO” exiting decision block 422, or visual feedback is presented to an operator of a recently transferred image as indicated in block 420, digital camera 100 enables an operator to determine whether further images are to be similarly modified and transferred from the digital camera 100 as illustrated in decision block 424. When more images are to modified and transferred, as indicated by the flow control arrow labeled “YES” exiting decision block 424, processing continues over blocks 404 through 424 until no further images are to be processed and method 400 terminates.

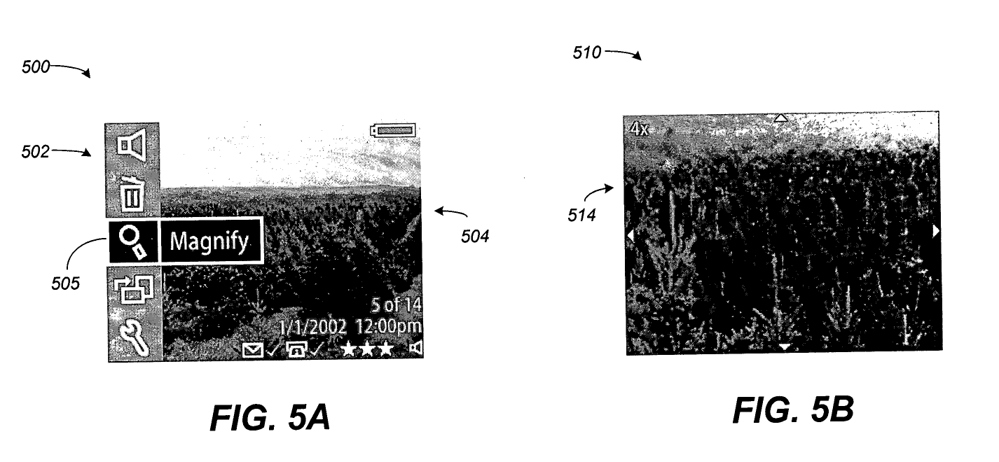

FIG. 5A is a graphical illustration showing an example of a magnification menu selection presented to a user of the digital camera 100. The display representation 500 illustrates a menu portion 502 and an image portion 504 displayed to a user via the image display 128. The menu portion 502 includes a “magnify” selection 505. When the user views the acquired displayed image 504, the user may enter the magnify view by, for example, actuating the OK/Select button 144 on the user interface 164 (FIG. 1) when the “magnify” option is highlighted. Entering the magnify view enables the magnification control 145 to vary the magnification level applied to the acquired displayed image. As is further described in association with the magnification range illustrated in FIG. 6, digital camera 100 can be pre-configured or otherwise programmed such that a series of subsequent images representing increasing magnification levels appears continuous to an operator of the digital camera 100. Similarly, a series of subsequent images representing decreasing magnification levels appears continuous to an operator.

FIG. 5B is a graphical illustration showing an example of the image of FIG. 5A magnified to an initial intermediate magnification step. In FIG. 5B, the image portion 504 is magnified to an initial intermediate magnification step of, for example, 4×, resulting in magnified image 514. The magnification logic 250 enables the magnification control 145 to provide variable magnification beginning at the 4× magnification step. The indicator in the screen shot 510, which indicates an initial “4×” magnification level, would change with the magnification levels responsible for changes in the magnification of the image 514. Further, position control 142 allows the user to navigate over different portions of the displayed image representation, so that a desired portion is centered or otherwise desirably positioned in the image display 128. The four directional arrows at the periphery of the image 514 indicate to a user of the digital camera 100 that position control 142 is enabled.

FIG. 6 is a diagram illustrating an embodiment of the magnification range 610 of the controllable magnification 600 of digital camera 100. In the example illustrated in FIG. 6, the magnification range 610 extends from a minimum magnification level of 1.5× to a maximum magnification of 6.0×. As further illustrated in the diagram, magnification logic 620 can be programmed to enter the magnification range 610 by applying an initial magnification level 620 selected between the minimum and maximum magnification levels. In the example shown in FIG. 6, the magnification logic 250 applies an initial magnification level of 4.0×. As shown by directional arrow 622, “zoom in” inputs entered via zoom in control 146 result in an increase in the magnification level from the initial magnification level 620. Conversely, “zoom out” inputs entered via zoom out control 147 result in a decrease in the magnification level from the initial magnification level 620. Note that while the scale of representative magnification levels over the magnification range 610 indicates that the magnification range spans from 1.5× to 6.0× the number of discrete magnification levels controllably selected via magnification control 145 is such that subsequent image representations corresponding to each discrete magnification level appear to be continuously variable in magnification over the magnification range 610.

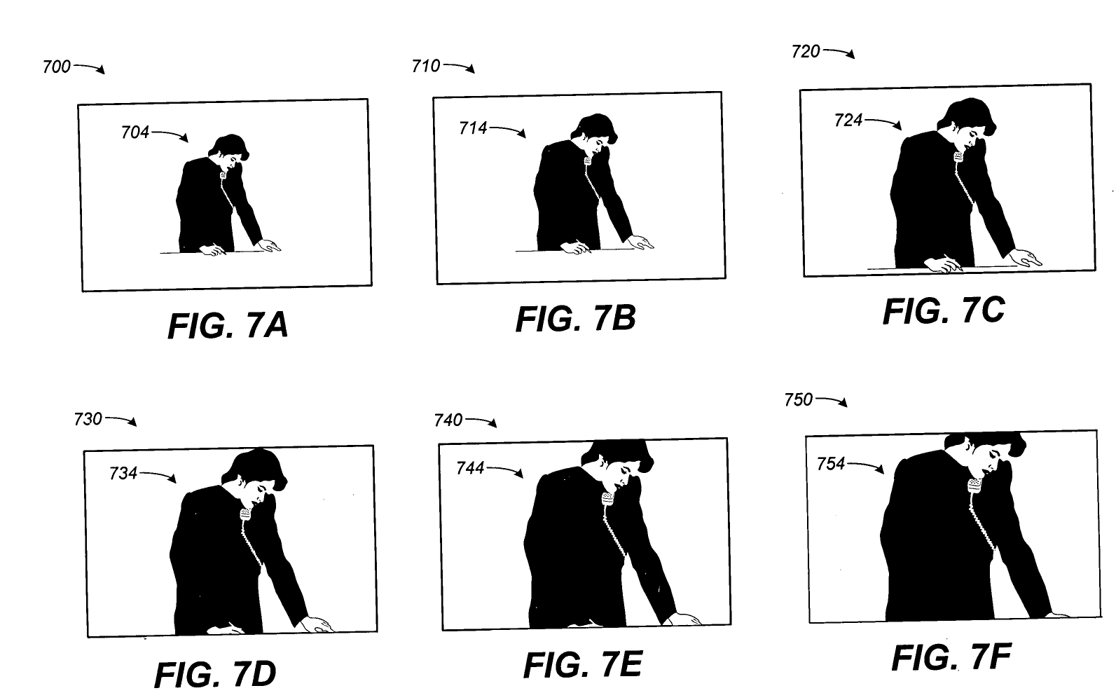

FIGS. 7A through 7F are graphical illustrations showing an example of the operation of the magnification logic 250. In FIG. 7A, an acquired image 704 is displayed on the image display 128 in screen shot 700 in playback mode. In FIG. 7B, the user has selected the magnification mode via the magnify menu selection in FIG. 5A, and the acquired image 704 of FIG. 7A is magnified, resulting in the magnified image 714 of FIG. 7B. The magnification applied to the acquired displayed image 704 is variable in both increasing magnification and decreasing magnification beginning at the initial intermediate magnification step via magnification control 145. FIGS. 7C through 7F illustrate progressively increasing magnification using magnification control 145, resulting in magnified images 724, 734, 744 and 754 in FIGS. 7C, 7D, 7E and 7F, respectively. The magnification is variable through the magnification range 610. Alternatively, an operator can controllably zoom out from the intermediate magnification step. For example, the user could decrease the magnification level from the initial 4× magnification to, for example, a 2× magnification.

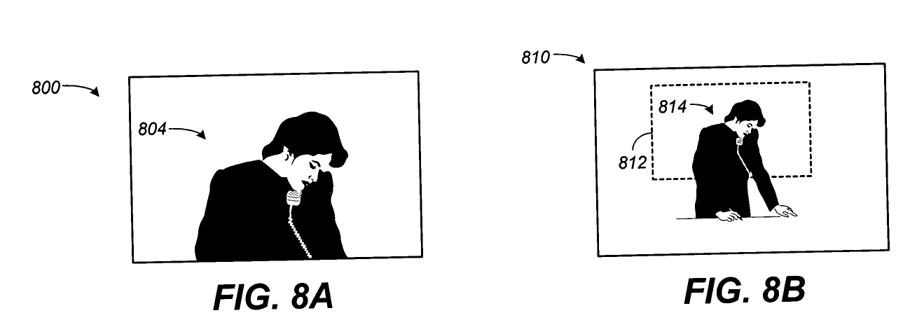

FIGS. 8A and 8B are graphical illustrations showing an example of the select 260. In FIG. 8A, the user of the digital camera 100 uses the 4-way position control 142 to controllably pan over the image representation 754 of FIG. 7F, resulting in a portion 804 of the image 704 of FIG. 4A centered in the image display 128, indicated in screen shot 800. The position control 142 allows the user to navigate over different portions of the acquired displayed image, so that the desired portion of the image to be transferred to a device coupled to the digital camera 100 is centered in the image display 128 as shown in FIG. 8A.

In FIG. 8B, the user has actuated the transfer control 148 or other control to indicate that the image 804 in FIG. 8A is to be transferred. The digital camera 100 then displays the originally acquired image including a bounding box 812 or some other indicia of a select area of the acquired image. The bounding box 812 indicates that the enclosed portion 814 of the acquired image is selected for transfer to a printer, computer, or other device coupled to the digital camera 100. When the digital camera 100 is connected to a printer, the image is transferred to the printer when the user actuates, for example, the transfer control 148 on the user interface 164. Additional portions of the original acquired image may be selected for transfer by using the magnification control 145 and the position control 142 to controllably select different portions of the acquired image.

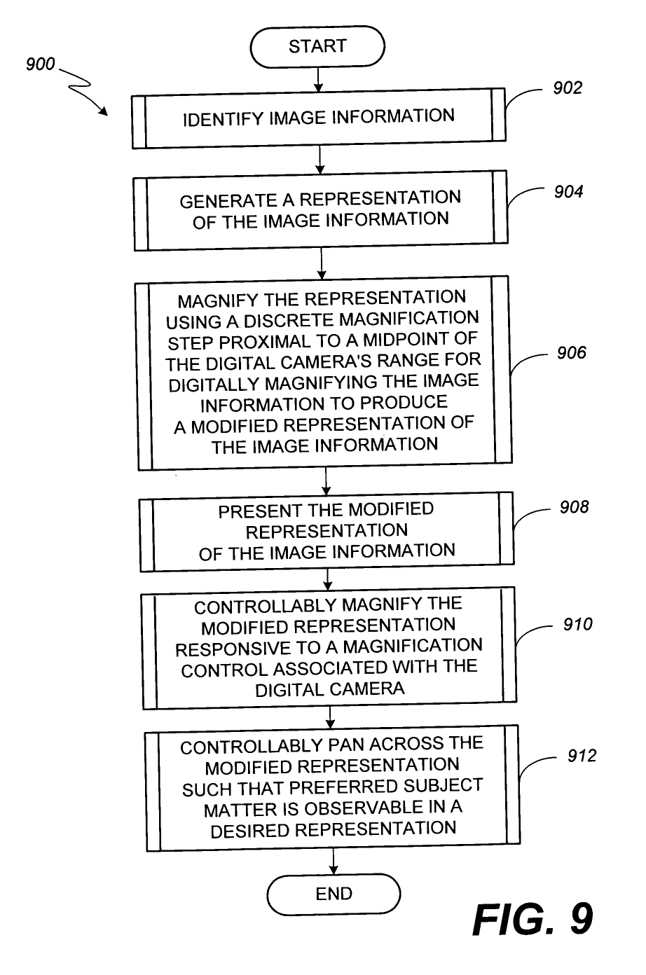

FIG.9 is a flow diagram illustrating an embodiment of a method for editing image information. Method 900 begins with block 902 where image information is identified. Thereafter, as indicated in block 904 a representation is generated using the image information. Next, as indicated in block 906, the representation is magnified using a discrete magnification step proximal to a midpoint of the digital camera's range for digitally magnifying the image information to produce a modified representation of the image information. The modified representation of the image information is presented as illustrated in block 908.

As indicated in block 910, method 900 continues by controllably magnifying the modified representation responsive to a magnification control associated with the digital camera. Method 900 also includes controllably panning across the modified representation such that preferred subject matter is observable in a desired representation as shown in block 912.

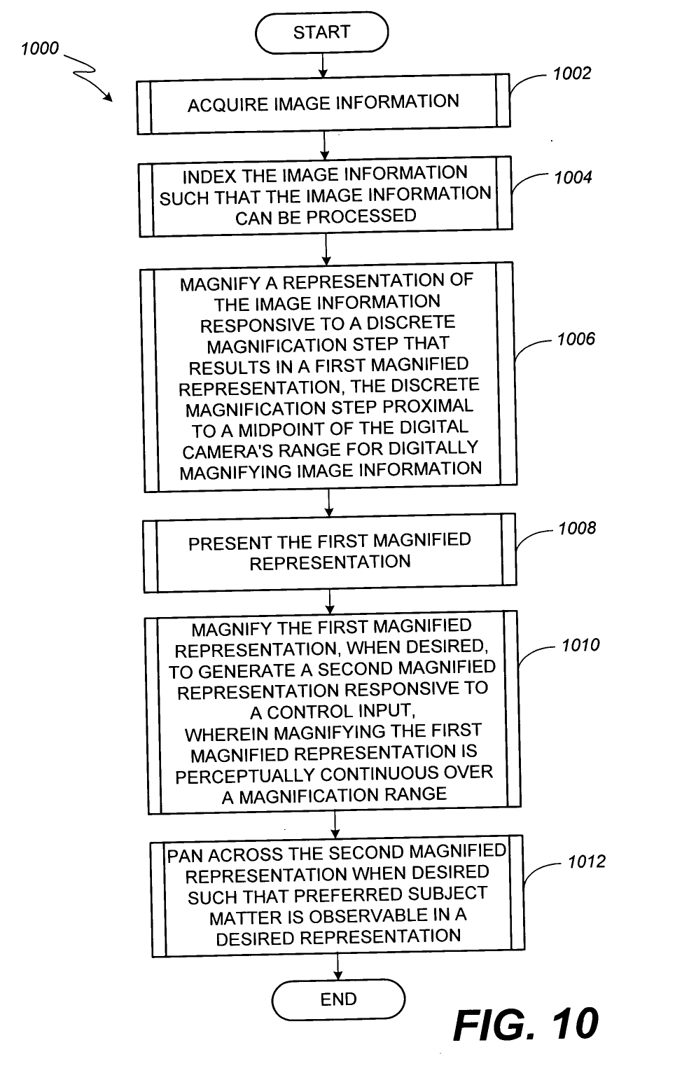

FIG. 10 is a flow diagram illustrating an alternative embodiment of a method for editing image information. Method 1000 begins with block 1002 where image information is acquired. Thereafter, as indicated in block 1004, the image information is indexed such that the image information can be processed. In block 1006, a representation of the image information is magnified responsive to a discrete magnification step, the discrete magnification step proximal to a midpoint of the digital camera's range for digitally magnifying the image information. The discrete magnification step results in a first magnified representation.

Next, as indicated in block 1008, the first magnified representation is presented. The first magnified representation is further magnified as desired to generate a second magnified representation responsive to a control input as shown in block 1010. The further magnification is responsive to a control input and results in a transition from the first magnified representation to the second magnified representation that is perceptually continuous over a magnification range. In addition, as indicated in block 1012, the second magnified representation is panned across, when desired, such that preferred subject matter is observable in a desired representation.

While various embodiments have been described, it will be apparent to those of ordinary skill in the art that many more embodiments and implementations are possible. All such modifications and variations are intended to be included herein within the scope of this disclosure and protected by the following claims.

1. A digital camera, comprising:
an image playback system that presents a representation of an image, wherein magnification logic responsive to a user preferred magnification step is applied to image information used to generate the representation;
a magnification control including a zoom in switch and a zoom out switch to effect respective zoom in and zoom out operations on the representation; and
a position control including an up switch, a down switch, a left switch, and a right switch to effect respective up, down, left, and right pan operations on the representation.

2. The digital camera of claim 1, further comprising:
a transfer control to effect a transfer operation of the image information associated with the representation as modified by the magnification and position controls to a device communicatively coupled to the digital camera.

3. The digital camera of claim 1, wherein the magnification logic applies a discrete magnification step proximal to a midpoint of the digital camera's range for digitally magnifying the image information.

4. The digital camera of claim 1, wherein operation of successive zoom in and zoom out operations, respectively occur in sufficiently small increments so as to be perceived by the user as continuous.

5. The digital camera of claim 1, further comprising logic for identifying that portion of the image information responsible for the representation.

6. The digital camera of claim 5, wherein the logic for identifying is responsive to the transfer control and presents visible indicia on the unmodified representation to demark a select portion of the image information.

7. The digital camera of claim 6, wherein the transfer operation forwards the select portion of the image information.

8. The digital camera of claim 1, further comprising:
an image acquisition system; and
a shutter that triggers the image acquisition system to acquire and index image information responsive to light incident upon an image sensor while the image playback means is active.

9. A method for editing image information with a digital camera, comprising:
identifying image information;
generating a representation of the image information;
magnifying the representation using a discrete magnification step proximal to a midpoint of the digital camera's range for digitally magnifying the image information to produce a modified representation of the image information;
presenting the modified representation of the image information;
controllably magnifying the modified representation responsive to a magnification control associated with the digital camera; and
controllably panning across the modified representation such that preferred subject matter is observable in a desired representation.

10. The method of claim 9, further comprising:
controllably transferring that portion of the image information corresponding to the desired representation.

11. The method of claim 9, wherein the step of controllably magnifying results in the presentation of successive modified representations of the image information that give the impression to a user that magnification is continuous.

12. The method of claim 9, further comprising:
activating the discrete magnification step via a menu selection.

13. The method of claim 9, further comprising:
enabling the image acquisition system to acquire image information responsive to light incident on an image sensor concurrently with any one of the identifying, generating, magnifying, panning, and transferring steps.

14. A computer-readable medium having a program for editing image information, the program comprising logic for:
acquiring image information;
indexing the image information such that the image information can be processed;
magnifying a representation of the image information responsive to a discrete magnification step that results in a first magnified representation, the discrete magnification step proximal to a midpoint of the digital camera's range for digitally magnifying the image information;
presenting the first magnified representation;
magnifying the first magnified representation, when desired, to generate a second magnified representation responsive to a control input, wherein magnifying the first magnified representation is perceptually continuous over a magnification range; and
panning across the second magnified representation, when desired, such that preferred subject matter is observable in a desired representation.

15. The computer-readable medium of claim 14, further comprising logic for:
transferring that portion of the image information corresponding to the desired representation.

16. The computer-readable medium of claim 15, wherein the logic for transferring forwards the select portion of the image information to a device communicatively coupled to a digital camera.

17. The computer-readable medium of claim 14, further comprising logic for generating a menu.

18. The computer-readable medium of claim 17, wherein the logic for generating a menu activates a menu option that when selected further activates the discrete magnification step.

19. The computer-readable medium of claim 14, further comprising logic for identifying that portion of the image information responsible for the representation.

20. The computer-readable medium of claim 14, further comprising logic for generating a transfer control that presents visible indicia on the unmodified representation to demark a select portion of the image information.

21. The computer-readable medium of claim 14, wherein the logic for acquiring information is accessible and executable concurrently with logic for indexing, presenting, magnifying, panning, and transferring image information.

22. A digital camera, comprising:
means for presenting a representation of an image responsive to a user preferred initial magnification step, wherein the user preferred initial magnification step is applied to image information to generate the representation;
means for effecting zoom in and zoom out operations on the representation; and
means for effecting up, down, left, and right pan operations on the representation.

23. The digital camera of claim 22, further comprising:
means for effecting a transfer of the image information associated with the representation as modified by the means for effecting zoom in and zoom out operations and means for effecting up, down, left, and right pan operations to a device communicatively coupled to the digital camera.

24. The digital camera of claim 23, wherein the means for effecting zoom in and zoom out operations on the representation applies magnification steps in sufficiently small increments so as to be perceived by the user as continuous.

25. The digital camera of claim 23, further comprising:
means for identifying that portion of the image information responsible for the representation.

26. The digital camera of claim 25, wherein the means for identifying is responsive to the means for effecting a transfer of the image information and presents visible indicia on the unmodified representation to demark a select portion of the image information.

27. The digital camera of claim 26, wherein the means for effecting a transfer of image information forwards the select portion of the image information.

28. The digital camera of claim 22, wherein the means for presenting applies a discrete magnification step proximal to a midpoint of the digital camera's range for digitally magnifying the image information.

29. The digital camera of claim 22, further comprising:
means for acquiring image information; and
means for triggering the means for acquiring image information such that the means for acquiring indexes image information responsive to light incident upon an image sensor while the means for presenting is active.
